(19) United States
(12) Patent Application Publication
(10) Pub. No.: US 2026/0153400 A1
(43) Pub. Date: Jun. 4, 2026

(54) SUBSEA CAPTURE TRAP OF A PIPELINE INSPECTION DEVICE AND METHOD FOR ASSEMBLING A SUBSEA CAPTURE TRAP OF A PIPELINE INSPECTION DEVICE

(71) Applicant: Petróleo Brasileiro S.A. - Petrobras, Rio de Janeiro (BR)

(72) Inventors: Heguiverton MARQUES DE SANTANA, Macaé (BR); Rodrigo SOARES MARTAO, Macaé (BR); Samuell COSTA DE SOUZA, Macaé (BR); Anderson Luiz DE OLIVEIRA PAIVA, Macaé (BR); Raphael MOREIRA DE BRITO, Rio de Janeiro (BR)

(73) Assignee: Petróleo Brasileiro S.A. - Petrobras, Rio de Janeiro (BR)

(21) Appl. No.: 19/400,982

(22) Filed: Nov. 25, 2025

(30) Foreign Application Priority Data
Dec. 4, 2024 (BR) 1020240253221

(51) Int. Cl. G01M 3/00

(52) U.S. Cl. CPC G01M 3/005

(57) ABSTRACT

A subsea capture trap of a pipeline inspection device includes: an inner flange having a first lateral projection and a second lateral projection, a first pin fitted into a hole located in the first lateral projection of the inner flange, a second pin fitted into a hole located in the second lateral projection of the inner flange, an outer flange connected to the first pin and to the second pin, a basket support fastened to the rear face of the outer flange by means of fastening elements fitted into an upper slot and a lower slot of the outer flange, and a basket having a base and a neck. The basket encases the basket support up to the rear face of the outer flange. The basket tapers from the base, which contacts the rear face of the outer flange, towards the neck.

### CROSS-REFERENCE TO RELATED APPLICATIONS

This application claims priority to Brazilian Patent Application No. 10 2024 025322 1, filed Dec. 4, 2024, the entire contents of which is incorporated herein by reference.

### FIELD

The present invention is applied in the field of maintenance and inspection technologies for subsea equipment used in the oil and gas industry, and, more particularly, relates to a subsea capture trap of a pipeline inspection device, commonly known as a “PIG” (Pipeline Inspection Gauge), and a method for assembling a subsea capture trap of a pipeline inspection device.

### BACKGROUND

Over the past few years, studies focused on analyzing aspects associated with the interconnection process of stationary production units (SPUs) have shown that post-connection activities of lines in the SPU (pull-in), especially with regard to interconnections with rigid pipelines, are complex and require a lot of operational diving time. Given that the inherent risks of the diving activity are very high, its safe execution requires the compliance with multiple external and internal standards and regulations, resulting in longer operations and subject to frequent interruptions.

In addition, since the SPUs are interconnected by pipeline systems, a rigorous inspection is necessary to ensure the integrity of the pipeline. This operation is usually carried out by using PIGs, which are launched from the surface (deck/topside of the vessel) and received at a certain depth, close to the seabed.

Thus, after the pull-in is completed and the line is positioned in its proper support, the pipeline is subjected to a hydrostatic test and PIG passage to confirm the tightness and integrity of the system.

Currently, to enable leak testing and subsequent PIG passage, equipment known as a Pig Launcher & Receiver (PLR) is used. The PLR, which is launched with the line itself, has a valve to allow sealing in the production tubing hanger (TH) and a chamber for receiving/launching the PIG. However, its dimensions, weight, and usage procedure require more diver time, and, in addition, are factors that make transportation and assembly using only a remotely operated vehicle (ROV) unfeasible.

Additionally, disconnecting and retrieving the PLR exposes the diver to significant operational risks, as well as requiring maneuvers with the SPU's load handling system.

Therefore, there is a gap in the state of the art for the development of a device capable of reducing operational time, risks of diving activities, and simplifying the operational steps of any subsea PIG reception activity, being applicable to the rigid pipeline interconnections of SPUs that do not have a solution for PIG reception on the surface (topside of the vessel).

Thus, the present invention presents a subsea capture trap of a pipeline inspection device (PIG) capable of eliminating the need for human diving intervention for the step of PIG subsea reception. In addition, even in cases where it is not possible to forgo the use of a diver, by using the trap of the present invention, it is possible to improve the HSE factor (health, safety and environment) by more than 30%. Furthermore, a reduction of at least 25% in the total intervention time can also be obtained.

### STATE OF THE ART

The state of the art shows some documents that disclose matters within the technological field of the present invention.

Document U.S. Pat. No. 5,027,466A discloses a PIG receiver for capturing a pipeline PIG as it is discharged or ejected from the oil pipeline. The receiver is easily attachable, detachable, and portable. The receiver includes a belt conduit made of flexible belt. The belt conduit includes a passage having a diameter approximately equal to the diameter of the pipeline to which it is connected. The belt conduit includes belts that extend longitudinally having loops formed at the ends of the belt. The receiver is connected to the pipeline flange by a chain arranged through the belt loops and is secured around the pipeline by a padlock or other fastener. The unconnected ends of the longitudinal belts are joined and fastened by a fastener, preferably a shackle that is arranged through the loops at the unconnected ends of the longitudinal belts.

However, in the present invention, the overall structure of the trap is made of metallic material, resistant and suitable for use underwater, with a predefined shape that does not change “at rest” or even by the impact of the PIG when it is ejected from the pipeline. On the other hand, the device in document U.S. Pat. No. 5,027,466A uses belts made of nylon or polyester, which are sewn together so that, when “at rest,” the structure tends to swing, attached to the pipeline flange. In addition, the closing mechanisms of the receiver ends in the aforementioned document U.S. Pat. No. 5,027,466A, essentially chains, clasps, and padlocks, require more complex handling and greater motor skills than that proposed by the present invention, which uses only pins for fitting into the flange (at the connection end with the flange) and dispenses with the use of fastening elements at the end furthest from the pipeline outlet, since the limitation of the PIG's displacement is the (tapered) geometry of the basket itself. Additionally, the use of chains attached to the rear face of the flange, as proposed by document U.S. Pat. No. 5,027,466A, could damage the flange, depending on the force and speed of the PIG when ejected through the pipeline, or even cause the receiver to detach. Furthermore, the aforementioned document does not disclose, or even suggest, the use of a basket support, which is encased by the basket, fastened to the outer flange; or even a flap that partially covers the pipeline outlet and prevents the PIG from returning to the pipeline. Moreover, given the receiver's structure in the aforementioned document, its installation via ROV does not seem conceivable.

In turn, document U.S. Pat. No. 3,303,525A refers to a receiver for foamed plastic tubing PIGS, comprising a frustoconical basket that can be positioned within an enlarged section of a tubing path to capture and retain a foamed plastic PIG that has been passed through the tubing.

However, the device disclosed by document U.S. Pat. No. 3,303,525A needs to be inserted inside a pipeline, called a “pig trap,” which is connected to the main line. In addition, the lower part of the basket is connected to an elongated rod that has a stop at its distal end, wherein the stop is in contact with a pipeline cap. The aforementioned document does not disclose, or even suggest, the use of a basket support, which is encased by the basket, fastened to the outer flange; or even a flap that partially covers the pipeline outlet and prevents the PIG from returning to the pipeline. Furthermore, the device in document U.S. Pat. No. 3,303,525A is used in conjunction with a traditional PLR system.

### SUMMARY

The solution of the present invention to the technical problem mentioned above consists of developing a subsea capture trap of a pipeline inspection device (PIG), installed on a submerged pipeline flange, to receive the pipeline inspection device. The use of the trap of the present invention allows to eliminate the need for human diving, as it can be transported and installed by a remotely operated vehicle (ROV). On the other hand, if there is no ROV available to perform the operation, for example, it is also possible for the trap to be transported and handled by a diver, since its structure is compact and lightweight, allowing the installation to be done quickly and efficiently (improvement of HSE).

The solution is applicable to PIG passage maneuvers, which are performed after the interconnections of rigid pipelines of SPUs that do not have a solution for receiving the PIG on topside. Some advantages and benefits obtained by the present invention are: —elimination of the diving intervention in the submerged reception of the PIG; —simplification and reduction of the maneuvers with a diver; —elimination of maneuvers with the SPU crane; —elimination of the step of PLR valve handling; —elimination of any diving intervention from the critical path of the pipeline hydrostatic test; —significant attenuation of operational risks for the diver; —element that is easy to manufacture and light enough to be transported by the diver himself or by an ROV.

Accordingly, the objectives and advantages of the present invention are achieved by providing a subsea capture trap of a pipeline inspection device comprising: an inner flange having a first lateral projection and a second lateral projection; a first pin fitted into a hole located in the first lateral projection of the inner flange; a second pin fitted into a hole located on the second lateral projection of the inner flange; an outer flange connected to the first pin and the second pin; a basket support fastened to the rear face of the outer flange by means of fastening elements fitted into an upper slot and a lower slot of the outer flange; and a basket having a base and a neck; wherein the basket encases the basket support up to the rear face of the outer flange; wherein the basket tapers from the base, which contacts the rear face of the outer flange, towards the neck.

In addition, the present invention also provides fastening, by means of fastening elements, of a tab on a rear face of an inner flange; fitting a first pin into a hole located on a first lateral projection of the inner flange and a second pin into a hole located on a second lateral projection of the inner flange; connecting an outer flange to the first pin and the second pin and threading hand screws into corresponding holes of the first and second pins to firmly secure the outer flange; fastening a basket support to a rear face of the outer flange by means of fastening elements fitted into an upper slot and a lower slot of the outer flange; encasing a basket in a basket support up to the rear face of the outer flange; fastening the basket to the outer flange by means of strap clamps that pass through holes of a plurality of holes and wrapping around a transverse wire of a base that contacts the rear face of the outer flange; and inserting the first pin and the second pin into holes of a pipeline flange, fastening the pins by means of nuts.

### BRIEF DESCRIPTION OF THE FIGURES

The preferred embodiments of the invention in question will be better understood when read together with the attached drawings. It should be understood, however, that the invention in question is not limited only to the precise arrangements and instruments as shown.

Thus, the present invention will now be described with reference to its typical embodiments and with reference to the appended drawings, in which:

FIG. 1 shows a rear isometric view of a subsea capture trap of a pipeline inspection device, according to an embodiment of the present invention.

FIG. 2 shows a front isometric view of a subsea capture trap of a pipeline inspection device, according to an embodiment of the present invention.

FIG. 3 shows a rear isometric view of an inner flange, pins and clamp of a subsea capture trap of a pipeline inspection device, according to an embodiment of the present invention.

FIG. 4 shows a side view of a basket support, an outer flange, an inner flange, and a clamp mounted on the pins of a subsea capture trap of a pipeline inspection device, according to an embodiment of the present invention.

FIG. 5 shows a front isometric view of a basket support, an outer flange, an inner flange, and a clamp mounted on the pins of a subsea capture trap of a pipeline inspection device, according to an embodiment of the present invention.

FIG. 6 shows a rear isometric view of a basket support, an outer flange, an inner flange, and a clamp mounted on the pins of a subsea capture trap of a pipeline inspection device, according to an embodiment of the present invention.

FIG. 7 shows a front isometric view of a subsea capture trap of a pipeline inspection device mounted on a pipeline flange, according to an embodiment of the present invention.

### DETAILED DESCRIPTION

Reference is made in detail to preferred embodiments of the present invention illustrated in the accompanying drawings. Whenever possible, the same or similar reference numbers will be used throughout the drawings to refer to identical or similar features. It should be noted that the drawings are in simplified form and are not represented to precise scale, so minor variations are expected.

Initially, it is worth to highlight that the words “pipeline(s)”, “pipe(s)”, “line(s)”, and others, as used throughout the text of the present invention, should not be interpreted in a specific or limiting way, but rather in a general way, often being used synonymously to refer to any type of tubular structure for transporting hydrocarbons, widely used and known in the oil and gas sector.

The present invention addresses to a subsea capture trap of a pipeline inspection device (PIG), applicable to PIG passage maneuvers, which are carried out after the interconnections of rigid pipelines of SPUs that do not have a solution for receiving the PIG on the surface (deck/topside of the vessels), and to a method for assembling a subsea capture trap of a pipeline inspection device.

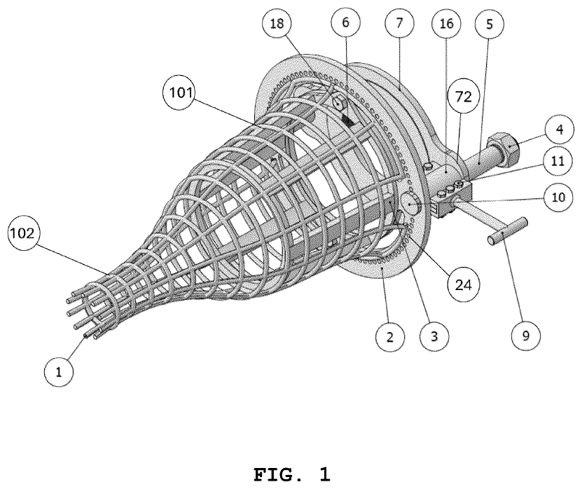

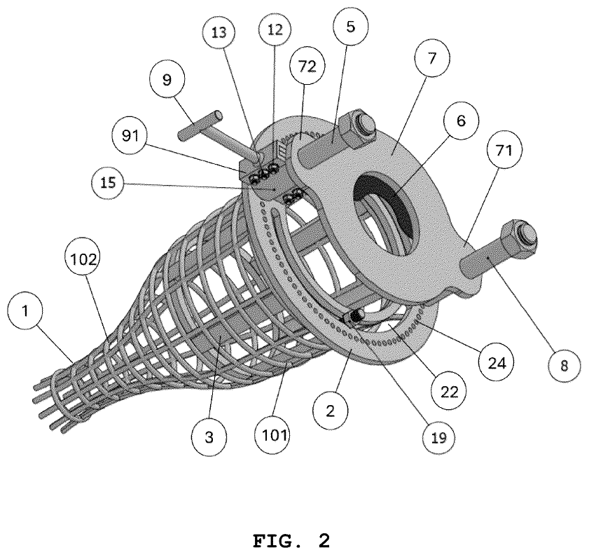

Thus, reference is made to FIGS. 1 and 2, which show a subsea capture trap of a pipeline inspection device, according to an embodiment of the present invention. The subsea capture trap comprises an inner flange (7) having a first lateral projection (71) and a second lateral projection (72). The inner flange (7) has a generally circular shape in its central portion, with oblong lateral portions, each lateral portion forming the first and second lateral projections (71, 72). In addition, the inner flange (7) further has a central opening.

Furthermore, according to one embodiment of the present invention, the inner flange (7) further comprises a flap (6) fastened to the rear face of the inner flange (7) and covering at least partially the central opening of the inner flange (7). It is worth to highlight that the flap (6) is fastened to the rear face of the inner flange (7) by means of fastening elements (14), such as rivets, screws, among others. The flap (6) has the function of preventing the pipeline inspection device from returning through the central opening, after having exited the pipeline and passed through the central opening of the inner flange (7). In embodiments of the present invention, the flap (6) is made of rubber; however, other materials may be used without departing from the objectives intended by the present invention.

Furthermore, the subsea capture trap further comprises a first pin (8) fitted into a hole located in the first lateral projection (71) of the inner flange (7) and a second pin (5) fitted into a hole located in the second lateral projection (72) of the inner flange (7).

The subsea capture trap, according to one embodiment of the present invention, further comprises an outer flange (2) connected to the first pin (8) and to the second pin (5); wherein the outer flange (2) is connected to the first pin (8) by means of a first hole located on the edge of the outer flange (2) and aligned with the hole located in the first lateral projection (71) of the inner flange (7); and the outer flange (2) is connected to the second pin (8) by means of a second hole, opposite the first hole, located on the edge of the outer flange (2) and aligned with the hole located in the second lateral projection (72) of the inner flange (7). In embodiments of the present invention, the outer flange (2) has a general circular shape, having an edge and a central opening; wherein the edge has an upper slot (21) and a lower slot (22). The outer flange (2) further includes a plurality of holes (24) which are arranged more externally radially on the edge in relation to the slots (21, 22) and run along the entire circular extent of the edge, each hole of the plurality of holes (24) being at the same distance from the center of the central opening.

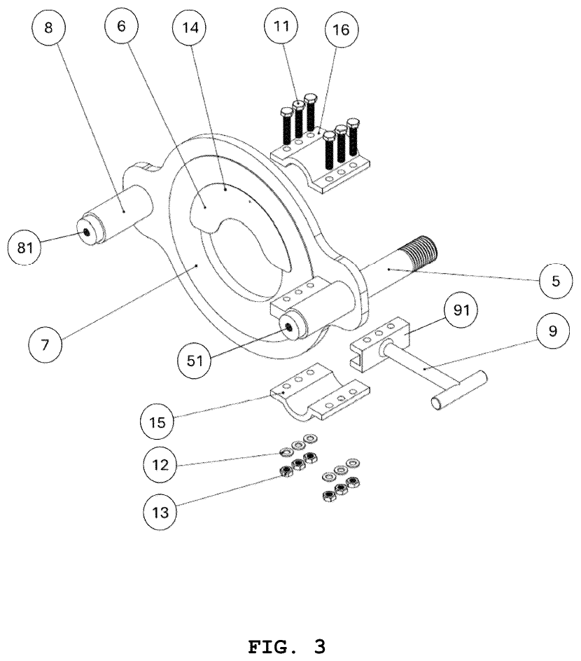

According to an embodiment of the present invention, the subsea capture trap further includes a clamp fastened to the second pin (5) and positioned between a rear face of the second lateral projection (72) and a front face of the outer flange (2). It should be noted that the clamp is positioned flush with both the rear face of the second lateral projection (72) of the inner flange (7) and the front face of the outer flange (2), thus defining a certain distance between the flanges (7, 2) and acting as a stop, preventing the flanges (7, 2) from displacing. As shown in more detail in FIG. 3, the clamp has a two-part structure formed by an upper portion (16) and a lower portion (15), each portion (16, 15) being saddle-shaped with two lateral edges. Thus, each of the upper portion (16) and the lower portion (15) is fitted around the second pin (5), being fastened to each other by means of fastening elements, such as screws (11), washers (12) and nuts (13).

In one embodiment of the present invention, an ROV handle (9) having an inverted “U” shaped base (91) is fitted onto the outermost lateral edges of the upper and lower portions (16, 15) of the clamp, so that the base (91) holds the outer surfaces of the outermost lateral edges of the upper and lower portions (16, 15) of the clamp, being secured to them by the fastening elements (11, 12, 13). The ROV handle (9) facilitates handling by an ROV during transport, assembly and operation of the capture trap. It is important to emphasize that although the ROV handle (9) is applicable to an ROV, its use should not be limited to the same, so that the ROV handle (9) can also be used by a human diver, for example, to facilitate handling of the subsea capture trap during transport, assembly and operation.

Furthermore, according to one embodiment of the present invention, hand screws (10) are fitted and threaded into corresponding holes (81, 51) of the first and second pins (8, 5) to firmly fasten the outer flange (2).

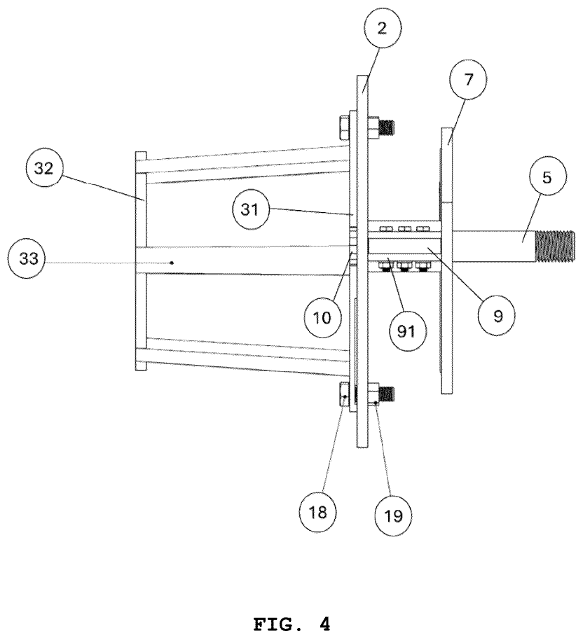

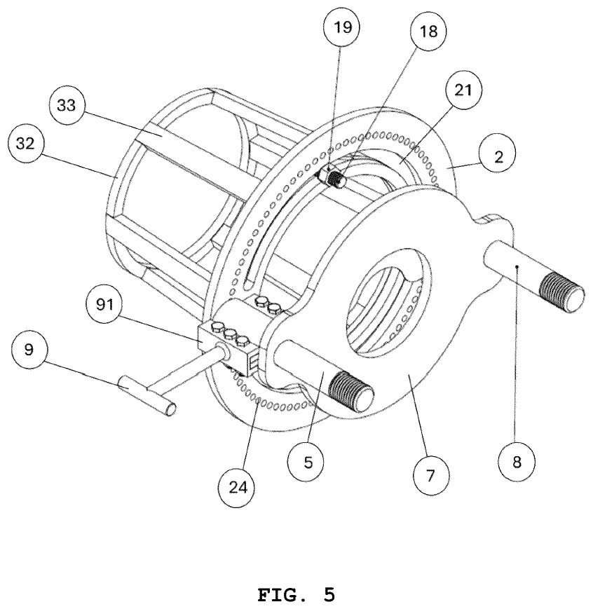

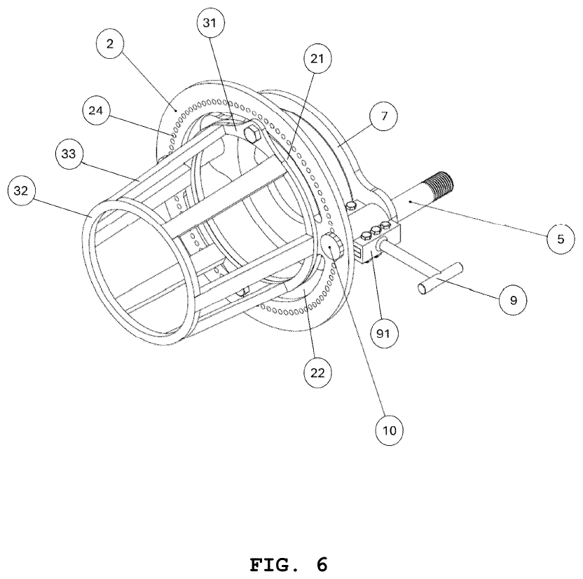

The subsea capture trap further comprises a basket support (3) fastened to the rear face of the outer flange (2) by means of fastening elements (18, 19) fitted into the upper slot (21) and the lower slot (22) of the outer flange (2). The basket support (3), as shown in greater detail in FIGS. 4, 5 and 6, is formed by a base portion (31) and a top portion (32), both in general ring shape, having a plurality of longitudinal bars (33) connecting the base portion (31) to the top portion (32) of the basket support (3). It is worth to highlight that the basket support (3) tapers from the base portion (31) towards the top portion (32), i.e., the diameter of the base portion (31) is greater than the diameter of the top portion (32).

Furthermore, according to an embodiment of the present invention, the subsea capture trap comprises a basket (1), formed by transverse and longitudinal wires, in general bottle shape, having a base (101) and a neck (102); wherein the basket (1) encases the basket support (3) up to the rear face of the outer flange (2); wherein the basket (1) tapers from the base (101), which contacts the rear face of the outer flange (2), towards the neck (102). In one embodiment of the present invention, the end of the neck (102) has an opening. This opening prevents some types of pipeline inspection devices that have extending elements, such as antennas, for example, from colliding with a barrier, so that the extending element can pass through the opening while the body of the pipeline inspection device is prevented from passing through the reduced diameter of the neck opening (102). It is worth to highlight that the base (101) surrounds the entire basket support (3), being supported by the same and, approximately from the height of the top portion (32) of the basket support (3), a more pronounced tapering occurs towards the end of the neck (102).

Furthermore, the basket (1) is fastened to the outer flange (2) by means of strap clamps (not shown) that pass through the holes of the plurality of holes (24) and wrap around the transverse wire of the base (101) that contacts the rear face of the outer flange (2), firmly securing the basket (1) to the outer flange (2).

Accordingly, according to a preferred embodiment of the present invention, the subsea capture trap of a pipeline inspection device comprises: an inner flange (7) having a first lateral projection (71) and a second lateral projection (72); a first pin (8) fitted into a hole located in the first lateral projection (71) of the inner flange (7); a second pin (5) fitted into a hole located in the second lateral projection (72) of the inner flange (7); an outer flange (2) connected to the first pin (8) and to the second pin (5); a basket support (3) fastened to the rear face of the outer flange (2) by means of fastening elements (18, 19) fitted into an upper slot (22) and a lower slot (23) of the outer flange (2); and a basket (1) having a base (101) and a neck (102); wherein the basket (1) encases the basket support (3) up to the rear face of the outer flange (2); wherein the basket (1) tapers from the base (101), which contacts the rear face of the outer flange (2), towards the neck (102).

Next, a method for assembling said subsea capture trap of a pipeline inspection device will be described, where the synergistic operation between the components of the present invention will become even more evident to a technician skilled on the subject.

Thus, as shown in FIG. 3, the method comprises a step of fastening, by means of fastening elements (14), a tab (6) on the rear face of an inner flange (7). Next, a first pin (8) is fitted into a hole located in a first lateral projection (71) of the inner flange (7) and a second pin (5) is fitted into a hole located in a second lateral projection (72) of the inner flange (7). In one embodiment of the present invention, the method further comprises a step of fitting a clamp around the second pin (5), the clamp being positioned between a rear face of the second lateral projection (72) and a front face of the outer flange (2) and fastened by means of fastening elements (11, 12, 13).

Furthermore, the method comprises a step of connecting the outer flange (2) to the first pin (8) and to the second pin (5) and threading hand screws into corresponding holes (81, 51) of the first and second pins (8, 5) to firmly secure the outer flange (2). Next, a basket support (3) is fastened to the rear face of the outer flange (2) by means of fastening elements (18, 19) fitted into the upper slot (22) and the lower slot (23) of the outer flange (2).

In one embodiment of the present invention, the method further comprises encasing the basket (1) in the basket support (3) up to the rear face of the outer flange (2) and fastening the basket (1) to the outer flange (2) by means of strap clamps that pass through the holes of the plurality of holes (24) and wrap around the transverse wire of the base (101) that contacts the rear face of the outer flange (2), firmly securing the basket (1) to the outer flange (2).

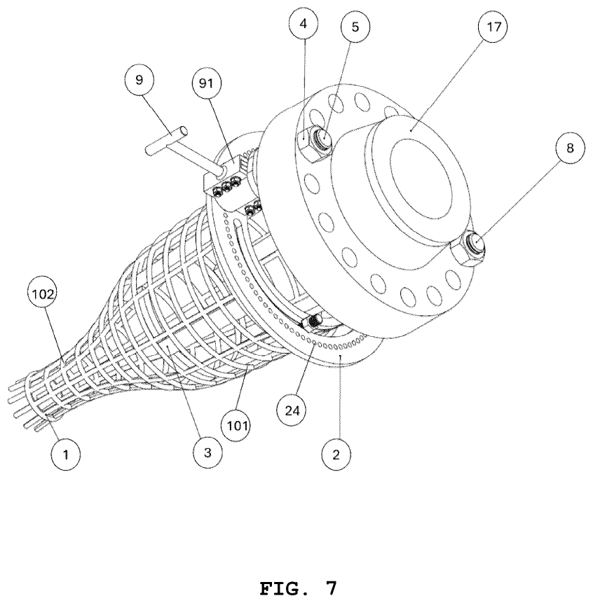

After fastening the basket (1) to the outer flange (2), an ROV or diver positions itself near a pipeline flange (17), as shown in FIG. 7, and inserts the first pin (8) and the second pin (5) into holes in the pipeline flange (17), fastening the pins (8, 5) by means of nuts (4) to complete the assembly of the subsea capture trap.

In this way, according to a preferred embodiment of the present invention, the method for assembling a subsea capture trap of a pipeline inspection device comprises: fastening, by means of fastening elements (14), a tab (6) on a rear face of an inner flange (7); fitting a first pin (8) into a hole located in a first lateral projection (71) of the inner flange (7) and a second pin (5) into a hole located in a second lateral projection (72) of the inner flange (7); connecting an outer flange (2) to the first pin (8) and to the second pin (5) and threading hand screws into corresponding holes (81, 51) of the first and second pins (8, 5) to firmly secure the outer flange (2); fastening a basket support (3) to a rear face of the outer flange (2) by means of fastening elements (18, 19) fitted into an upper slot (22) and a lower slot (23) of the outer flange (2); encasing a basket (1) in a basket support (3) up to the rear face of the outer flange (2); fastening the basket (1) to the outer flange (2) by means of strap clamps that pass through holes of a plurality of holes (24) and wrapping around a transverse wire of a base (101) that contacts the rear face of the outer flange (2); and inserting the first pin (8) and the second pin (5) into holes of a pipeline flange (17), fastening the pins (8, 5) by means of nuts (4).

Those skilled in the art will appreciate the knowledge presented herein and may reproduce the invention in the embodiments presented and in other variants, encompassed within the scope of the appended claims.

1. A subsea capture trap of a pipeline inspection device, comprising:
an inner flange having a first lateral projection and a second lateral projection;
a first pin fitted into a hole located in the first lateral projection of the inner flange;
a second pin fitted into a hole located in the second lateral projection of the inner flange;
an outer flange connected to the first pin and to the second pin;
a basket support fastened to the rear face of the outer flange by means of fastening elements fitted into an upper slot and a lower slot of the outer flange; and
a basket having a base and a neck; wherein the basket encases the basket support up to the rear face of the outer flange;
wherein the basket tapers from the base, which contacts the rear face of the outer flange, towards the neck.

2. The subsea capture trap of claim 1, wherein the inner flange has a generally circular shape in its central portion; and
oblong lateral portions, each lateral portion forming the first and second lateral projections.

3. The subsea capture trap of claim 1, wherein the inner flange further comprises a flap fastened to the rear face of the inner flange and covering at least partially the central opening of the inner flange.

4. The subsea capture trap of claim 1, wherein the outer flange is connected to the first pin by means of a first hole located on the edge of the outer flange and aligned with the hole located on the first lateral projection of the inner flange.

5. The subsea capture trap of claim 1, wherein the outer flange is connected to the second pin by means of a second hole, opposite the first hole, located on the edge of the outer flange and aligned with the hole located on the second lateral projection of the inner flange.

6. The subsea capture trap of claim 1, wherein the outer flange has a generally circular shape, having an edge and a central opening; wherein the edge has an upper slot and a lower slot.

7. The subsea capture trap of claim 1, wherein the outer flange further includes a plurality of holes which are arranged more externally radially on the edge in relation to the slots and run along the entire circular length of the edge, each hole of the plurality of holes being at the same distance from the center of the central opening.

8. The subsea capture trap of claim 1, further comprising a clamp fastened to the second pin and positioned between a rear face of the second lateral projection and a front face of the outer flange.

9. The subsea capture trap of claim 8, wherein the clamp has a two-part structure formed by an upper portion and a lower portion, each portion being saddle-shaped with two lateral edges.

10. The subsea capture trap of claim 1, further comprising an ROV handle having an inverted “U” shaped base, wherein the base is fitted over the outermost lateral edges of the upper and lower portions of the clamp, such that the base holds the outer surfaces of the outermost lateral edges of the upper and lower portions of the clamp.

11. The subsea capture trap of claim 1, wherein hand screws (10) are fitted and threaded into corresponding holes of the first and second pins to firmly secure the outer flange (2).

12. (canceled)

13. The subsea capture trap of claim 1, wherein the basket support is formed by a base portion, a top portion, and a plurality of longitudinal bars connecting the base portion to the top portion of the basket support.

14. The subsea capture trap of claim 1, wherein the basket support tapers from the base portion towards the top portion.

15. The subsea capture trap of claim 1, wherein the end of the neck has an opening.

16. The subsea capture trap of claim 1, wherein the basket is fastened to the outer flange by means of strap clamps that pass through the holes of the plurality of holes and wrap around the transverse wire of the base that contacts the rear face of the outer flange, firmly securing the basket to the outer flange.

17. A method for assembling a subsea capture trap of a pipeline inspection device, comprising:
fastening, by means of fastening elements, a tab to a rear face of an inner flange;
fitting a first pin into a hole located in a first lateral projection of the inner flange and a second pin into a hole located in a second lateral projection of the inner flange;
connecting an outer flange to the first pin and to the second pin and threading hand screws into corresponding holes of the first and second pins to firmly secure the outer flange;
fastening a basket support to a rear face of the outer flange by means of fastening elements fitted into an upper slot and a lower slot of the outer flange;
encasing a basket in a basket support to the rear face of the outer flange;
fastening the basket to the outer flange by means of strap clamps that pass through holes of a plurality of holes and wrapping around a transverse wire of a base that contacts the rear face of the outer flange; and
inserting the first pin and the second pin into holes in a pipeline flange, fastening the pins by means of nuts.

18. The method of claim 17, further comprising fitting a clamp around the second pin , the clamp being positioned between a rear face of the second lateral projection and a front face of the outer flange and fastened by means of fastening elements.
